(19) United States
(12) Patent Application Publication
(10) Pub. No.: US 2020/0007565 A1
(43) Pub. Date: Jan. 2, 2020

(54) PASSIVE AUTOMATED CONTENT ENTRY DETECTION SYSTEM

(71) Applicant: eBay Inc., San Jose, CA (US)

(72) Inventor: Sergio Pinzon Gonzales, JR., San Jose, CA (US)

(21) Appl. No.: 16/025,976

(22) Filed: Jul. 2, 2018

(51) Int. Cl. H04L 29/06

(52) U.S. Cl. CPC H04L 63/1425; H04L 2463/144; H04L 63/1416; H04L 63/20

(57) ABSTRACT

An automated content entry detection system to identify inputs received automated agents. Aspects of the automated content entry system include various functional components to perform operations that include: receiving entries that comprise inputs into one or more data entry fields from user accounts; determining behavioral data of the entries based on one or more input attributes of the entries; generating a prediction to be assigned to the user accounts based on the one or more attributes of the entries; and performing operations that include denying further requests received from the automated agents based on the prediction.

### TECHNICAL FIELD

The subject matter of the present disclosure generally relates methods and systems supporting network security.

### BACKGROUND

Millions of computer systems worldwide are infected by malware that cause the computer systems to function as automated agents which may be controlled by malicious actors, forming “bot-nets.” The infected computer systems may be coordinated and used by the malicious actors to perform a variety of illegal activities, including perpetrating identity theft, sending billions of spam messages, launching denial of service (DoS) attacks, committing click fraud, and so on. The infected computer system also may experience a significant waste in resources that result in a loss of performance. Thus, without verification checks, automated agents can place incorrect data into product reviews or ratings. If that is done the reviews and ratings may be inaccurate.

Completely Automated Public Turing tests, or “CAPTCHA,” may be used to identify and prevent such automated agents from performing actions which reduce the overall quality of services supported by a networked system, whether due to outright abuse or resource expenditure. For example, a common type of CAPTCHA involves a user typing letters or digits from a distorted image that appears at a portion of an interface displayed at a device.

While such tests have been effective in the past, advances in automated software technology have made the detection of such software increasingly difficult under existing security protocols. Furthermore, CAPTCHA and other similar tests to identify automated software are often inconvenient or burdensome to many genuine users. It is therefore an object of the present invention to provide an improved system for the detection of such automated agents and malicious actors.

### BRIEF DESCRIPTION OF THE DRAWINGS

Various ones of the appended drawings merely illustrate example embodiments of the present disclosure and are not intended to limit its scope to the illustrated embodiments. On the contrary, these examples are intended to cover alternatives, modifications, and equivalents as may be included within the scope of the disclosure.

FIG. 1 is a block diagram illustrating various functional components of an automated content entry detection system, which is provided as part of the networked system, according to example embodiments.

FIG. 2A is a flowchart illustrating a method for detecting an automated agent, according to an example embodiment.

FIG. 2B is a flowchart illustrating a method for detecting an automated agent, according to an example embodiment.

FIG. 3 is a flowchart illustrating a method for detecting an automated agent after an entry into a data entry field, according to an example embodiment.

FIG. 4 is a flowchart illustrating a method for detecting an automated agent after an entry into a data entry field, according to an example embodiment.

FIG. 5 is a flowchart illustrating a method for detecting an automated agent after an entry into a data entry field, according to an example embodiment.

FIG. 6 is a flowchart illustrating a method for detecting an automated agent after an entry into a data entry field, according to an example embodiment.

FIG. 7 is a flowchart illustrating a method for detecting an automated agent after an entry into a data entry field, according to an example embodiment.

FIG. 8 is a flowchart illustrating a method for detecting an automated agent after an entry into a data entry field, according to an example embodiment.

FIGS. 9 and 10 are interaction diagrams illustrating various operations performed by an automated content entry detection system, according to certain example embodiments.

FIG. 11 illustrates a diagrammatic representation of a machine in the form of a computer system within which a set of instructions may be executed for causing the machine to perform any one or more of the methodologies discussed herein, according to an example embodiment

### DETAILED DESCRIPTION

Humans have a pattern of data entry that is different and distinguishable from automated agents (e.g., bots). Historically, Morse code operators could be identified based on their characteristic pattern of signal clicks, referred to as a Morse code operator's “fist.” Conversely, automated agents tend to enter data in predictable, repeatable, and consistent patterns, or patterns that could be determined that are being entered algorithmically. For example, when a human being is entering the fields on an online entry form, they will click in each form field and type in their response. The response will typically have errors, and the process of typing the response will have backspaces, deletions, pauses, and sequential typing entries. An automated agent on the other hand, will have a pre-programmed repository of responses that may be used to populate a form in one action—like a “copy-paste.” The automated agent may enter whole blocks of text at once, in rapid succession.

Thus, a system may passively monitor input attributes and characteristics in order to calculate a likelihood that a particular user is actually an automated agent. In response to determining that the user is an automated agent, the system may perform follow up operations to prevent abuse of a networked system, that include: blocking further inputs from the user identified as the automated agent; directing the user to a dead-end interface (i.e., a honeypot); building an automated agent profile in order to more quickly identify subsequent automated agents; and notifying an administrator with information about the automated agent.

A system that monitors input attributes and characteristics solves a technical problem of ensuring accuracy of data input into a database or computer system. In addition, a technical problem exists around solving the problem in a computationally efficient way. For example, traditional CAPTCHA tests may involve sending a puzzle to be solved to the client, receiving a response, and processing the response. Still further, traditional CAPTCHA tests involve using the human operator's time and efficiency by presenting the puzzle and require interaction. By monitoring input, and processing inputs, technical problems of accuracy in data is solved (ensuring it is valid data), and efficiency of the machines is improved by decreased round trips in the network and decreased presentation and processing of puzzles to be solved on the client and server. Monitoring of input involves technical solutions, such as monitoring pressure measurements, measuring and determining frequency of phrases or characters within strings, measurements of time between keypresses, and other computational tasks. Technical effects include improvement of network bandwidth, reduction of computational processor cycles used to solve the problems, and increased operator efficiency.

Reference will now be made in detail to specific example embodiments for carrying out the inventive subject matter of the present disclosure. In the following description, specific details are set forth in order to provide a thorough understanding of the subject matter. It shall be appreciated that embodiments may be practiced without some or all of these specific details.

Below are described various aspects of an automated content entry detection system to identify inputs received automated agents. According to certain example embodiments, aspects of the automated content entry system include various functional components to perform operations that include: receiving entries that comprise inputs into one or more data entry fields from user accounts; determining behavioral data of the entries based on one or more input attributes of the entries; generating scores to be assigned to the user accounts based on the one or more attributes of the entries; identifying automated agents based on the scores; and performing operations that include denying further requests received from the automated agents.

The one or more attributes of the entries include behavioral and biometric data, such as keystroke dynamics, as well as device attributes (eg., device identifier, device type), and user attributes (e.g., user identifier, IP address). Keystroke dynamics provide an indication of the manner and rhythm in which any given user types characters on a keyboard of keypad. This keystroke rhythm may be measured to develop a unique biometric template of a user's typing pattern for future authentication. In some embodiments, data needed to analyze keystroke dynamics may be obtained through keystroke logging in order to identify attributes such as the time it takes to get to and depress a key (i.e., seek-time), the time that any given key is held-down (i.e., hold-time), a speed of entry for a given sequence of keys, and a consistency of the speed of entry of the given sequence of keys, a pressure of a tactile input and a consistency of the pressure of the tactile input, as well as common errors and corrections of errors (i.e., frequently typing “fo” rather than “of” before making a correction).

In some example embodiments, the one or more attributes of the entries may include a time of day in which an entry was received by the system. For example, the automated content entry detection system may assign timestamps to entries received from a user account, and analyze the timestamps to determine regular patterns of activity. For example, the patterns may indicate that a particular user account is most active during specific hours of a day, certain days of a week, or even seasonally. Thus, if an entry is received and assigned a timestamp outside of the regular period of activity, the automated content entry detection system may generate a score that reflects uncertainty that the user account is currently being operated by the genuine user, and may instead be an automated agent.

In some example embodiments, the one or more attributes of the entries may include motion and image data captured by a client device. For example, the motion and image data may be collected via an accelerometer, altimeter, gyroscope, camera/front facing camera. Automated agents utilizing a compromised user account often provide entries to data entry forms from a server, or stationary device, whereas a user of a user account may instead provide inputs into a mobile device. As a result, it may be possible to infer whether a user is providing inputs into their usual mobile device based on the amount and type of movement recorded by the mobile device through the accelerometer, gyroscope, and altimeter of the mobile device. Similarly, a front facing camera may be utilized to capture images to determine whether or not a genuine user of the mobile device is providing the entries into the mobile device or not.

The automated content entry detection system generates one or more scores to be assigned to a user account dynamically based on the one or more attributes of the inputs received from the user account, in real-time. The scores may comprise a likelihood (e.g., a percent likelihood) that: the entries received from the user account were generated by a genuine human user; a likelihood that the entries received from the user account were generated by an automated agent; as well as a likelihood that the user account is compromised and may be executed by a malicious user. In some example embodiments, the score may be generated based on various learning algorithms that compare a similarity or exactness between various attributes of the entries into data entry fields.

Consider an illustrative example for purposes of explanation. The cadence or rhythm in which a user types certain letters, or certain combinations of letters (e.g., words, phrases) may have an associated score. For example, a user may provide an entry comprising an input that includes the text string “SAMPLE.” Based on an evaluation of the attributes of repeated entries of the text string “SAMPLE,” the automated content entry detection system may determine attributes of the entry that include: the speed of the entry as a whole, as well as a speed of successive sequences of keys (i.e., that the input is consistently typed out at a certain speed, or that “S” and “A” are pressed at a consistent speed); specific selection of keys for the entry (i.e., the use of the left shift-key rather than Caps Lock or the right shift-key); and an identification of consistent misspelling and corrections of the misspelling. Each of these attributes may be assigned to a corresponding user account, as well as to the inputs themselves. Thus, as subsequent entries are received from the user account, or subsequent entries that include similar inputs are received from the user account, the automated content entry detection system may utilize a learning algorithm to perform a comparison between the subsequent entries received from the user account, and the entry attributes assigned to the user account or the inputs in order to identify similarities and patterns. The automated content entry detection system may thereby generate the score to be assigned to the user account based on the identified similarities and patterns.

In some embodiments, the automated content entry detection system may define a threshold value (e.g., 60%), wherein the threshold indicates a user is likely to be an automated agent or malicious actor. In other embodiments, a threshold may not be entered by a user—instead, a machine may determine an output prediction of whether entry was from an automated agent or not. In the case of a threshold, the score assigned to the user account based on the entries received from the user account may be compared to the threshold value. In response to detecting the score assigned to the user account transgress the threshold value, the automated content entry detection system may flag or otherwise indicate that entries from the user account may be generated by an automated agent, or a malicious actor that has hi-jacked the user account. Subsequent entries received from the user account may thereby be denied, or the user account may be blocked from accessing resources of a network at all.

In some embodiments, a threshold is not explicitly set, and machine learning techniques may instead be employed to generate an output that comprises a prediction of whether or not an entry may or may not have been generated by an automated agent. For example, a machine learning model associated with the automated content entry detection system is initially trained using a training dataset that comprises inputs received from a user account, and in some embodiments from a plurality of user accounts that may include automated agents.

In such embodiments, the automated content entry detection system may determine behavioral data of a first entry, wherein the behavioral data includes one or more attributes of the first entry. The one or more attributes may be placed into a machine prediction module configured by the machine learning model trained by the training dataset. The automated content entry detection system inputs the one or more attributes of the first entry into the machine prediction module in response to receiving the first entry. The machine prediction module may then generate a prediction as an output based on the one or more attributes of the first entry, wherein the output comprises an indication of a likelihood that the first entry was generated by an automated agent. The automated content entry detection system receives the output from the machine prediction module, and associates the output with the user account. For example, the output may indicate that the first entry received from the user account is received from an automated agent. Based on the output indicating that the first entry was received from an automated agent, subsequent entries received from the user account may be denied.

In some embodiments, the determination of whether the user account is an automated agent may be generated at a client device, separate from the automated content entry detection system, and subsequently distributed to the automated content entry detection system for comparison with the threshold value. For example, the client device may itself collect and determine attributes of entries into data in order to generate a score and profile of a user account. The profile of the user account may be hosted and maintained entirely at the client device, such that the automated content entry detection system itself may only receive access to the score itself, and not to the attributes utilized to generate the score.

In further embodiments, the determination of whether the user account is an automated agent may be generated and maintained locally to the automated content entry detection system. In such embodiments, attributes of entries may be collected and hosted at a database of the automated content entry detection system, and utilized to generate a score to be assigned to the user account locally.

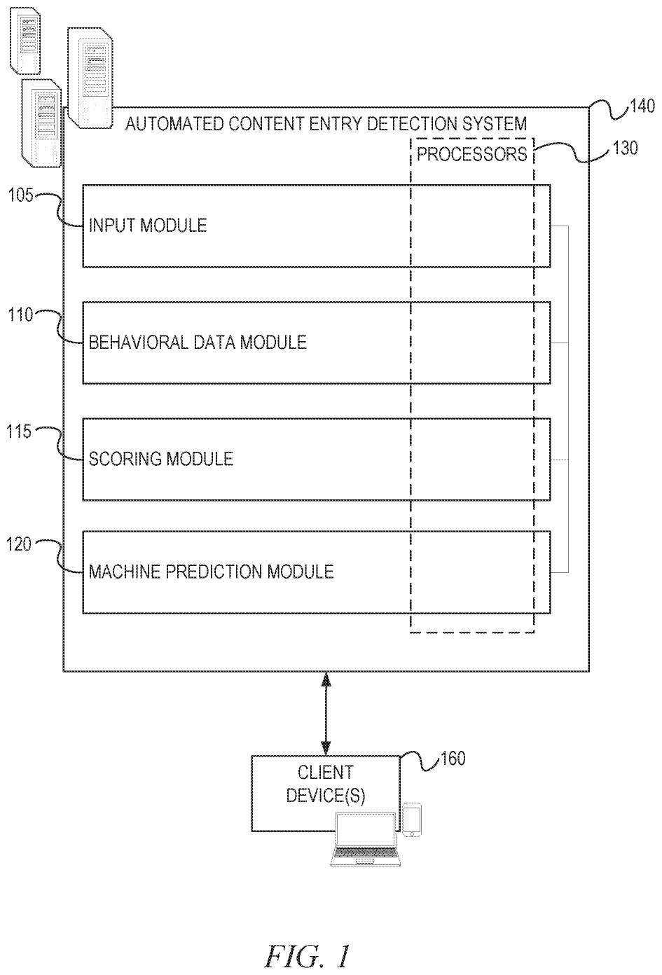

FIG. 1 is a block diagram illustrating components of an automated content entry detection system 140 that provide functionality to identify applications utilizing out of date keys, and to automatically update the out of date keys, according to certain example embodiments. The automated content entry detection system 140 is show as including an input module 105 to receive entries into data entry fields from a client device 160, a behavioral data module 110 to determine behavioral data of the entries into the data entry fields, a scoring module 115 to generate a score to be assigned to a user account based on attributes of the behavioral data, and in some embodiments, a machine prediction module 120 configured by a machine learning model, all configured to communicate with each other (e.g., via a bus, shared memory, or a switch). Any one or more of these modules may be implemented using one or more processors 130 (e.g., by configuring such one or more processors to perform functions described for that module) and hence may include one or more of the processors 130.

Any one or more of the modules described may be implemented using dedicated hardware alone (e.g., one or more of the processors 130 of a machine) or a combination of hardware and software. For example, any module described of the automated content entry detection system 140 may physically include an arrangement of one or more of the processors 130 (e.g., a subset of or among the one or more processors of the machine) configured to perform the operations described herein for that module. As another example, any module of the automated content entry detection system 140 may include software, hardware, or both, that configure an arrangement of one or more processors 130 (e.g., among the one or more processors of the machine) to perform the operations described herein for that module. Accordingly, different modules of the automated content entry detection system 140 may include and configure different arrangements of such 130 or a single arrangement of such processors 130 at different points in time. Moreover, any two or more modules of the automated content entry detection system 140 may be combined into a single module, and the functions described herein for a single module may be subdivided among multiple modules. Furthermore, according to various example embodiments, modules described herein as being implemented within a single machine, database, or device may be distributed across multiple machines, databases, or devices.

In some example embodiments, one or more modules of the automated content entry detection system 140 may be implemented within the client device 160. For example, the behavioral data module 110 and scoring module 115 may reside within the client device 160, and may determine behavioral data and generate a score to be assigned to a user account based on attributes of the behavioral data at the client device 160.

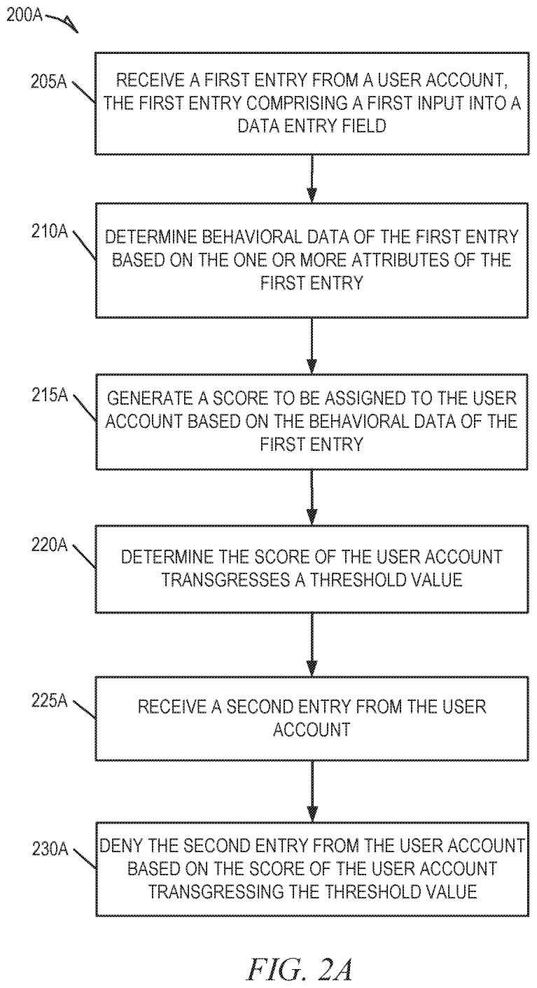

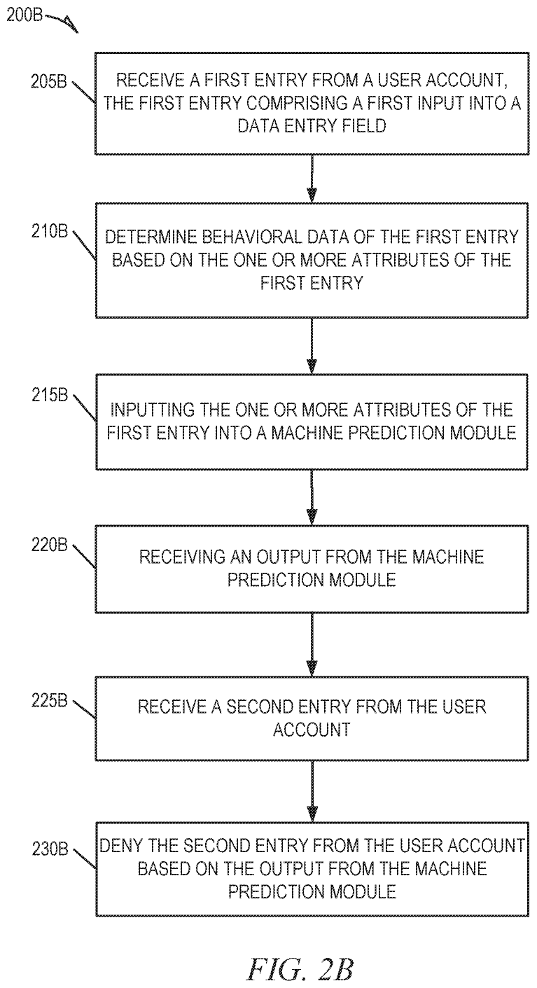

FIG. 2A is a flowchart illustrating a method 200A for detecting an automated agent based, according to an example embodiment. The method 200A may be embodied in computer-readable instructions for execution by one or more processors (e.g., processors 130 of FIG. 1) such that the steps of the method 200A may be performed in part or in whole by functional components (e.g., modules) of a client device or the automated content entry detection system 140; accordingly, the method 200A is described below by way of example with reference thereto. However, it shall be appreciated that the method 200A may be deployed on various other hardware configurations and is not intended to be limited to the functional components of the client device or the automated content entry detection system 140.

At operation 205A, the input module 105 receives a first entry from a user account, wherein the first entry includes an input that comprises one or more attributes into a data entry field. The data entry field may be presented to the user account via a client device 160 within a presentation of a graphical user interface (GUI). A user may provide the input by the client device 160 and into the data entry field. The data entry field may for example include a field presented within a GUI configured for receiving a text based entry or a numerical based entry. A user of the client device 160 may select the data entry field and provide an input into the data entry field, whereby the entry is received by the input module 105.

At operation 210A, the behavioral data module 110 determines behavioral data of the first entry based on the one or more attributes of the first entry. In some embodiments, the behavioral data module 110 may be implemented by one or more processors of the client device 160 itself. In further embodiments, the behavioral data module 110 may be implemented by the one or more processors 130 of the automated content entry detection system 140.

According to some example embodiments, the attributes of the first entry may include keystroke dynamics, temporal data, location data, biometric data, as well as motion data and image data. For example, one or more of the attributes of the first entry may be determined based on keystroke logging to identify attributes such as the time it takes to get to and depress a key (i.e., seek-time), the time that any given key is held-down (i.e., hold-time), a speed of entry for a given sequence of keys, and a consistency of the speed of entry of the given sequence of keys, a pressure of a tactile input and a consistency of the pressure of the tactile input, as well as common errors and corrections of errors.

At operation 215A, according to one example embodiment, the scoring module 115 generates an output to be assigned to the user account, based on the one or more attributes of the entry determined by the behavioral data module 110. The output may for example a score that includes a percentage value, wherein the percentage may indicate a likelihood that: the entries received from the user account were generated by a genuine human user; a percentage likelihood that the entries received from the user account were generated by an automated agent; as well as a percentage likelihood that the user account is compromised and may be executed by a malicious user. Equally, the output may simply comprise an affirmative indication of whether the user account is an automated agent or a legitimate user of the user account.

In some example embodiments, the score may be generated by the scoring module 115 dynamically, as entries are received from the user account, in real-time. The score generated by the scoring module 115 may be based on a similarity or exactness of various attributes of the entry with prior entries received from the user account, or in some embodiments a similarity or exactness of the various attributes of the entry to entry attributes received from automated agents. For example, the user account may include a record that indicates an expected input pressure, typing speed, or seek time for a particular input. Similarly, the behavioral data module 110 may also maintain a database of entry attributes of inputs received from automated agents. The scoring module 115 may compare the attributes of the entry to prior attributes of similar inputs of the user account and the database of attributes associated with automated agents to determine a similarity, and generate the score of the entry based on the similarity (e.g., more similar to what is expected from the user, or more similar to what is expected from the automated agents). The score of the entry may thereby be assigned to the user account, wherein a composite, or cumulative score, of all inputs received from the user account may be generated and maintained.

At operation 220A, the scoring module 115 determines that the score associated with the user account transgresses a threshold value. The threshold value may indicate a likelihood that entries received from the user account may have been generated by an automated agent. In response to detecting the score assigned to the user account transgress the threshold value, the scoring module 115 flags or otherwise indicates that the user account may be compromised, and subsequent entries received from the user account may thereby be denied, or the user account may be blocked from accessing resources of a network at all.

At operation 225A, the input module 105 receives a second entry from the user account. The second entry may for example comprise an input into a second data entry field presented within the GUI displayed at the client device 160. In response to receiving the second entry from the user account, and based on the score assigned to the user account, at operation 230A, the input module 105 denies the second entry from the user account. In some embodiments, the input module 105 may notify an administrator of the automated content entry detection system 140 of the user account, based on the score assigned to the user account.

FIG. 2B is a flowchart illustrating a method 200B for detecting an automated agent based, according to an example embodiment. The method 200B may be embodied in computer-readable instructions for execution by one or more processors (e.g., processors 130 of FIG. 1) such that the steps of the method 200B may be performed in part or in whole by functional components (e.g., modules) of a client device or the automated content entry detection system 140; accordingly, the method 200B is described below by way of example with reference thereto. However, it shall be appreciated that the method 200B may be deployed on various other hardware configurations and is not intended to be limited to the functional components of the client device or the automated content entry detection system 140.

At operation 205B, as in operation 205A, the input module 105 receives a first entry from a user account, wherein the first entry includes an input that comprises one or more attributes into a data entry field. The data entry field may be presented to the user account via a client device 160 within a presentation of a graphical user interface (GUI). A user may provide the input by the client device 160 and into the data entry field. The data entry field may for example include a field presented within a GUI configured for receiving a text based entry or a numerical based entry. A user of the client device 160 may select the data entry field and provide an input into the data entry field, whereby the entry is received by the input module 105.

At operation 210B, the behavioral data module 110 determines behavioral data of the first entry based on the one or more attributes of the first entry. In some embodiments, the behavioral data module 110 may be implemented by one or more processors of the client device 160 itself. In further embodiments, the behavioral data module 110 may be implemented by the one or more processors 130 of the automated content entry detection system 140.

According to some example embodiments, the attributes of the first entry may include keystroke dynamics, temporal data, location data, biometric data, as well as motion data and image data. For example, one or more of the attributes of the first entry may be determined based on keystroke logging to identify attributes such as the time it takes to get to and depress a key (i.e., seek-time), the time that any given key is held-down (i.e., hold-time), a speed of entry for a given sequence of keys, and a consistency of the speed of entry of the given sequence of keys, a pressure of a tactile input and a consistency of the pressure of the tactile input, as well as common errors and corrections of errors.

At operation 215B, the behavioral data module 110 inputs the one or more attributes of the first entry into the machine prediction module 120, wherein the machine prediction module 120 includes a machine learning model trained using a training dataset that comprises inputs received from a user account, and in some embodiments from a plurality of user accounts that may include automated agents.

At operation 220B, the machine prediction module 120 generates an output based on the machine learning model and the one or more input attributes of the first entry, wherein the output comprises an indication of whether or not the first entry is received from an automated agent. For example, in some embodiments, the output may simply comprise a binary statement of whether or not the first entry was received from an automated agent, while in further embodiments the output may include a score such as a percentage likelihood (e.g., 80% automated agent).

At operation 225B, the input module 105 receives a second entry from the user account, subsequent to the machine prediction module 120 generating the output that indicates the first entry was received from an automated agent. The second entry may for example comprise an input into a second data entry field presented within the GUI displayed at the client device 160. In response to receiving the second entry from the user account, at operation 230B, the input module 105 denies the second entry from the user account, based on the output received from the machine prediction module 120. In some embodiments, the input module 105 may notify an administrator of the automated content entry detection system 140 of the user account, based on the output.

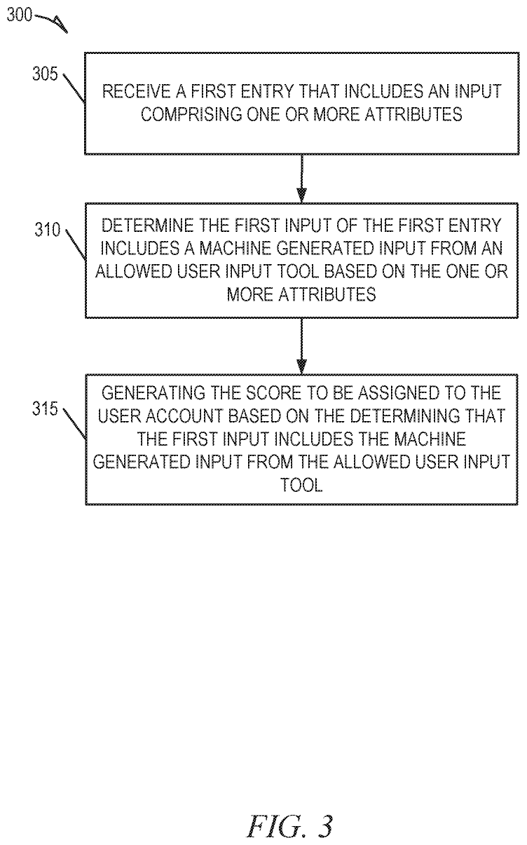

FIG. 3 is a flowchart illustrating a method 300 for generating a score for an entry into a data entry field, according to an example embodiment. The method 300 may be embodied in computer-readable instructions for execution by one or more processors (e.g., processors 130 of FIG. 1) such that the steps of the method 300 may be performed in part or in whole by functional components (e.g., modules) of a client device 160 or the automated content entry detection system 140; accordingly, the method 300 is described below by way of example with reference thereto. The method 300 may be performed as a subroutine or subsequent to the method 200, according to an example embodiment.

At operation 305, as in operation 205 of the method 200, the input module 105 receives a first entry from a user account, wherein the first entry comprises an input into a data entry field. The data entry field may be presented to the user account via a client device 160 within a presentation of a graphical user interface (GUI). A user may provide the input by the client device 160 and into the data entry field, wherein the input includes input attributes such as an input type. The data entry field may for example include a field presented within a GUI configured for receiving a text based entry or a numerical based entry. A user of the client device 160 may select the data entry field and provide an input into the data entry field, whereby the entry is received by the input module 105.

At operation 310, the behavioral data module 110 determines that the first input of the first entry includes a machine generated input from an allowed user input tool, based on one or more attributes of the first entry. For example, the machine generated input may include a copy-paste command, or a seller tool input. In response to receiving the input from the client device in operation 305, the automated content entry detection system 140 may compare attributes of the first input to a user account of the user, or to a database of entries received from automated agents to identify similarities. Based on the comparison, the various modules of the automated content entry detection system 140 determine that the machine generated input includes a machine generated input from an allowed user input tool.

At operation 315, the scoring module 115 generates a score to be assigned to the user account based on the one or more attributes of the first entry. For example, the scoring module 115 may access the user account to retrieve one or more attributes of similar inputs to the machine generated input. The scoring module 115 generates the score based on a similarity of the one or more attributes of the similar inputs to the one or more attributes of the machine generated input.

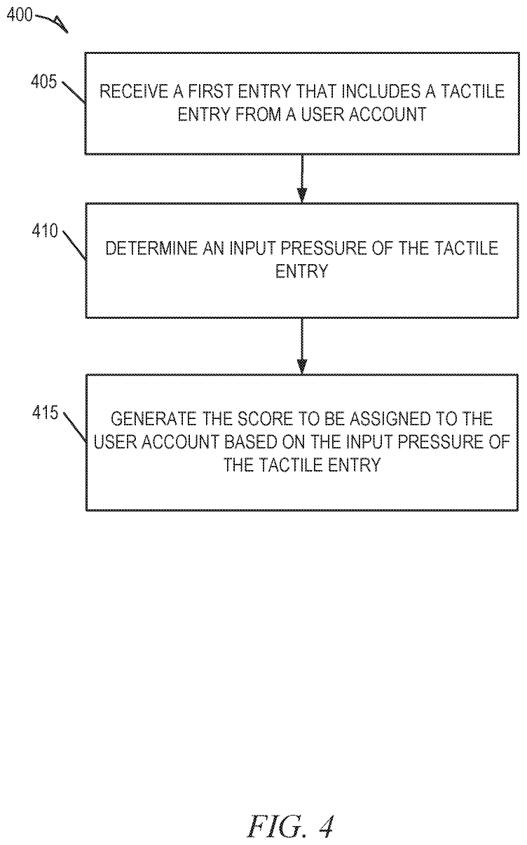

FIG. 4 is a flowchart illustrating a method 400 for generating a score for an entry into a data entry field, according to an example embodiment. The method 400 may be embodied in computer-readable instructions for execution by one or more processors (e.g., processors 130 of FIG. 1) such that the steps of the method 400 may be performed in part or in whole by functional components (e.g., modules) of a client device 160 or the automated content entry detection system 140; accordingly, the method 400 is described below by way of example with reference thereto. The method 400 may be performed as a subroutine or subsequent to the operations of the method 200, according to an example embodiment.

At operation 405, as in operation 205 of the method 200, the input module 105 receives a first entry from a user account, wherein the first entry comprises an input into a data entry field. The data entry field may be presented to the user account via a client device 160 within a presentation of a graphical user interface (GUI). In some embodiments, the client device 160 may be configured to receive tactile entries, and the first entry from the user account may include a tactile entry.

At operation 410, the behavioral data module 110 determines an input pressure of the tactile entry, based on the one or more attributes of the first entry. For example, in some embodiments, the client device 160 may be configured to measure and record an input pressure amount of tactile entries. This may involve measuring pressure applied to a key across the time of a keypress, measuring a maximum pressure applied to a key, a minimum pressure applied to a key during a keypress, or other similar pressure measurement. It is especially useful on touch screens and operating systems that allow the pressure applied to a key to be derived from operating system events.

At operation 415, the scoring module 115 generates a score to be assigned to the user account based on the input pressure of the tactile entry. For example, the scoring module 115 may access the user account to retrieve input pressures of similar inputs to the first entry, in order to determine a similarity between the input pressures of the similar inputs to the input pressure of the first entry. The scoring module 115 generates the score based on the similarity, and assigned the score to the user account, whereby the scoring module may calculate a composite, or cumulative score to be compared to the threshold value.

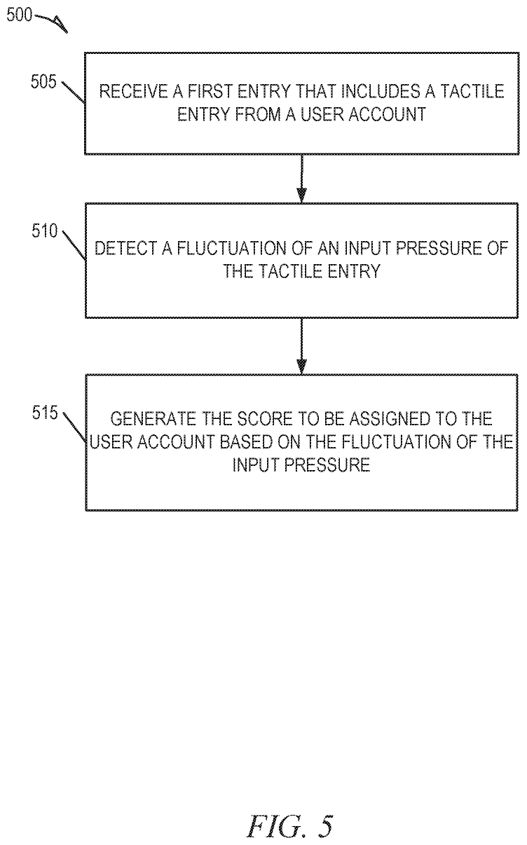

FIG. 5 is a flowchart illustrating a method 500 for generating a score for an entry into a data entry field, according to an example embodiment. The method 500 may be embodied in computer-readable instructions for execution by one or more processors (e.g., processors 130 of FIG. 1) such that the steps of the method 500 may be performed in part or in whole by functional components (e.g., modules) of a client device 160 or the automated content entry detection system 140, accordingly, the method 500 is described below by way of example with reference thereto. The method 500 may be performed as a subroutine or subsequent to operations of the method 200, according to an example embodiment.

At operation 505, as in operation 205 of the method 200, the input module 105 receives a first entry from a user account, wherein the first entry comprises an input into a data entry field. The data entry field may be presented to the user account via a client device 160 within a presentation of a graphical user interface (GUI). In some embodiments, the client device 160 may be configured to receive tactile entries, and the first entry from the user account may include a tactile entry.

At operation 510, the behavioral data module 110 detects a fluctuation of an input pressure of the tactile entry, based on the one or more attributes of the first entry. For example, in some embodiments, the client device 160 may be configured to measure and record an input pressure of tactile entries. The behavioral data module 110 may detect a fluctuation in input pressures of the tactile entries. For example, the tactile entries may include text inputs, wherein the text inputs comprise a series of tactile inputs into the client device 160. The behavioral data module 110 may determine that one or more of the tactile inputs that comprise the text inputs represent a fluctuation (e.g., a significant increase or decrease) in input pressure.

As an illustrative example, consider a user providing an input into the client device 160 to spell the world “example.” The user may press harder on some letters than others. Because automated agents typically provide inputs that may record a minimum input pressure, or at least a uniform input pressure, a fluctuation in input pressure may indicate that the user account is not being used by an automated agent. At operation 515, the scoring module 115 generates a score to be assigned to the user account based on the fluctuation of the input pressure.

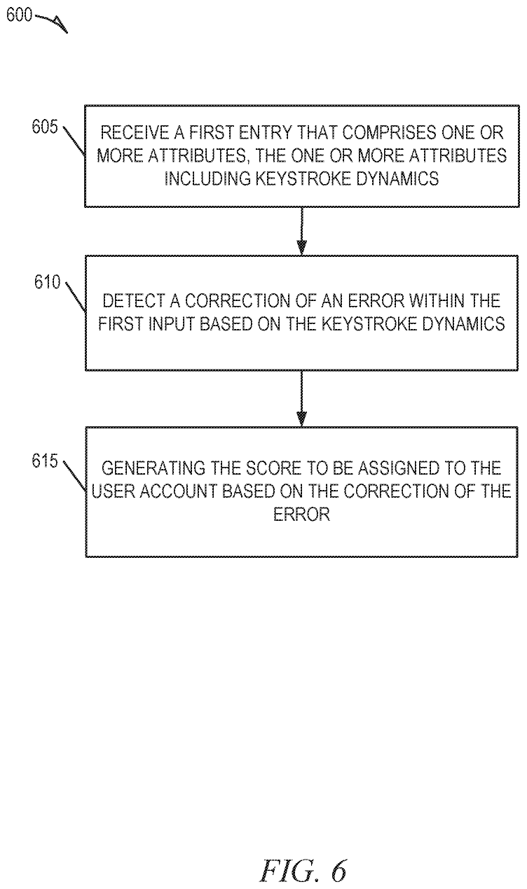

FIG. 6 is a flowchart 600 illustrating a method for generating a score for an entry into a data entry field, according to an example embodiment. The method 600 may be embodied in computer-readable instructions for execution by one or more processors (e.g., processors 130 of FIG. 1) such that the steps of the method 600 may be performed in part or in whole by functional components (e.g., modules) of a client device 160 or the automated content entry detection system 140, accordingly, the method 600 is described below by way of example with reference thereto. The method 600 may be performed as a subroutine or subsequent to operations of the method 200, according to an example embodiment.

At operation 605, the input module 105 receives a first entry from a user account, wherein the first entry includes an input into a data entry field. In some embodiments, the first input comprises one or more attributes that include keystroke dynamics, wherein the keystroke dynamics provide an indication of the manner and rhythm in which any given user types characters on a keyboard of keypad.

In response to the input module 105 receiving the first entry, at operation 610, the behavioral data module 110 detects a correction of an error within the first input based on the one or more attributes that include the keystroke dynamics. For example, the keystroke dynamics may indicate a specific keystroke pattern that the user applied to correct the error that may for example include the backspace key, or the delete key, or a mouse/cursor to select, delete, and correct the error within the first input.

At operation 615, in response to detecting the correction of the error, the scoring module 115 generates a score to be assigned to the user account based on the correction of the error. In some embodiments, the score may be generated based on a comparison of the keystroke pattern applied by the user to the user account, in order to determine whether or not a similar keystroke pattern has been applied by the user in the past to correct similar errors. In further embodiments, the mere application of the keystroke pattern may be sufficient to generate the score.

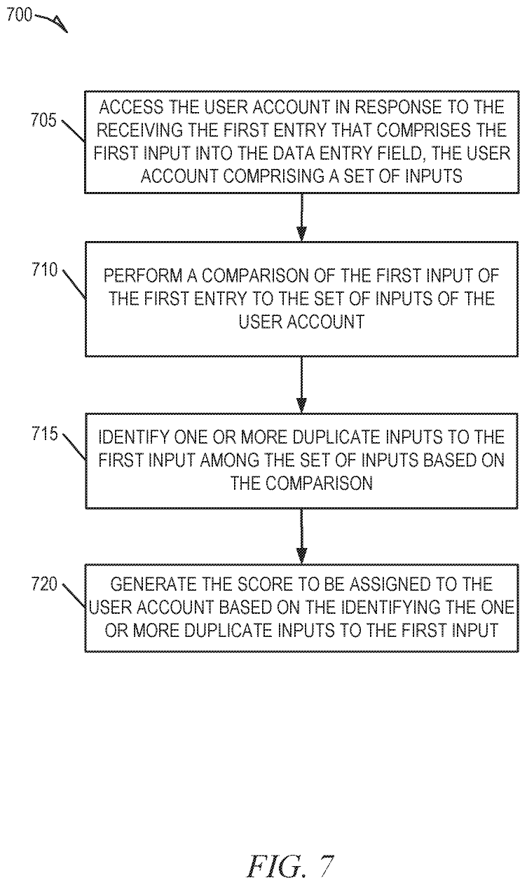

FIG. 7 is a flowchart 700 illustrating a method for generating a score for an entry into a data entry field, according to an example embodiment. The method 700 may be embodied in computer-readable instructions for execution by one or more processors (e.g., processors 130 of FIG. 1) such that the steps of the method 700 may be performed in part or in whole by functional components (e.g., modules) of a client device 160 or the automated content entry detection system 140, accordingly, the method 700 is described below by way of example with reference thereto. The method 700 may be performed as a subroutine or subsequent to operations of the method 200, according to an example embodiment.

At operation 705, in response to receiving the first entry that comprises the first input into the data entry field, the behavioral data module 110 accesses the user account, wherein the user account comprises a record of prior inputs received from the user account, and the corresponding attributes of the prior inputs. For example, the behavioral data module 110 may maintain a record of entries received from the user account, such that the record comprises indications of attributes of the entries.

At operation 710, the scoring module 115 performs a comparison of the first input of the first entry to the record of entries of the user account. At operation 715, the scoring module 115 identifies one or more duplicate inputs among the record of entries to the first input of the first entry into the data entry field.

At operation 720, the scoring module 115 generates the score to be assigned to the user account based on a comparison of the attributes of the duplicate inputs to the one or more attributes of the first entry. As discussed above, the score may be based on a similarity of the attributes, such that a greater degree of similarity may indicate that the user of the user account is the genuine user, whereas a lesser degree of similarity may indicate that the user account is compromised. In some embodiments, however, an extremely high degree of exactness between the attributes of the one or more duplicate inputs and the first input may be an indication that the user account is being utilized by an automated agent.

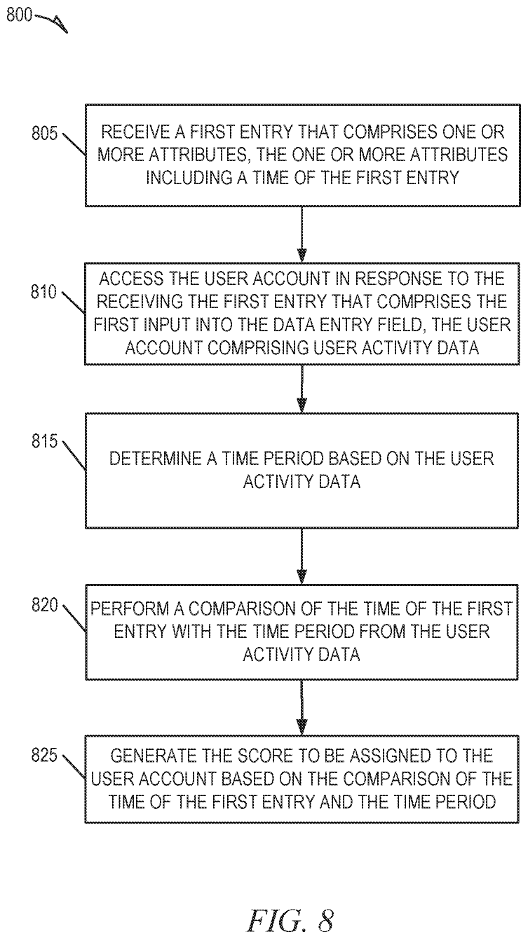

FIG. 8 is a flowchart illustrating a method 800 for generating a score for an entry into a data entry field, according to an example embodiment. The method 800 may be embodied in computer-readable instructions for execution by one or more processors (e.g., processors 130 of FIG. 1) such that the steps of the method 800 may be performed in part or in whole by functional components (e.g., modules) of a client device 160 or the automated content entry detection system 140: accordingly, the method 800 is described below by way of example with reference thereto. The method 800 may be performed as a subroutine or subsequent to operations of the method 200, according to an example embodiment.

At operation 805, the input module 105 receives a first entry from a user account, wherein the first entry includes a first input that comprises one or more attributes, wherein the one or more attributes include temporal data. The temporal data includes a timestamp that indicates a time of day in which the first entry was received by the input module 105.

At operation 810, in response to the input module 105 receiving the first entry from the user account, the behavioral data module 110 accesses the user account to retrieve user activity data. In some embodiments, the user activity data of the user account may provide an indication of regular hours of activity of the user. For example, the user activity data may indicate that the user is most active at specific times of the day, or days of the week, or seasonally.

In some embodiments, the user activity data may provide an indication of regular hours of activity based on input type. For example, the user activity data may indicate that a first input type are primarily received from the user account at a first time, whereas a second input type are primarily received from the user account at a second time.

At operation 815, the behavioral data module 110 determines a time period based on the user activity data of the user account and the first input of the first entry. For example, the time period may indicate an expected period of activity for the first input.

At operation 820, the scoring module 115 performs a comparison of the temporal data from the first entry with the expected period of activity retrieved from the user account. Based on the comparison, at operation 825, the scoring module generates a score to be assigned to the user account. In such embodiments, if the temporal data of the first entry is far outside of the expected period of activity, the score may reflect that the user account may be compromised. For example, “far outside,” may mean that the first entry was received twelve hours off schedule of what is normal for the user.

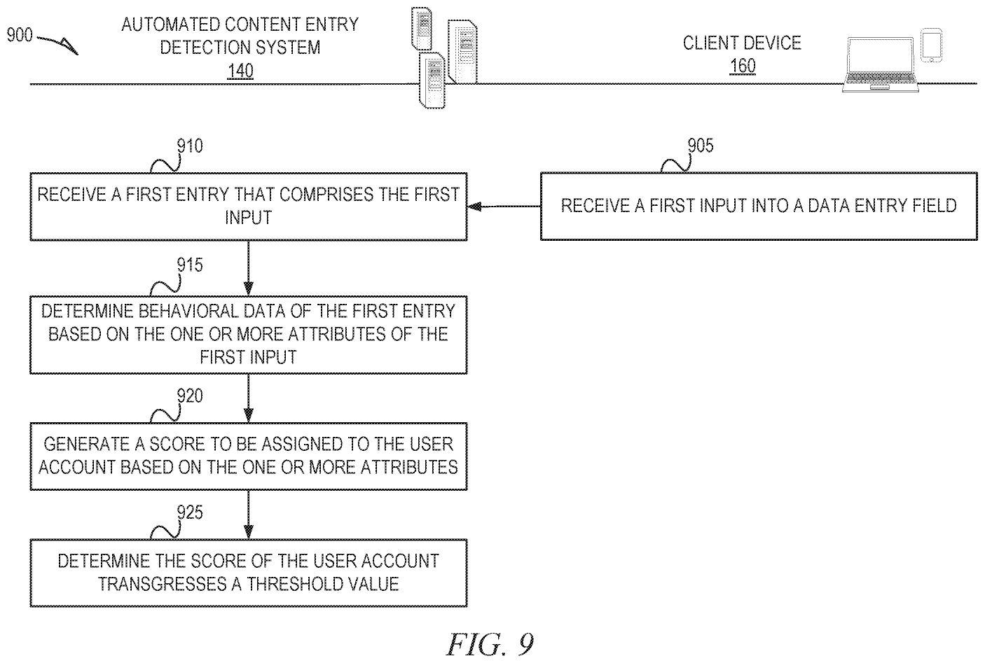

FIG. 9 is an interaction diagram 900 illustrating various operations performed by the automated content entry detection system 140, according to an example embodiment. The interaction diagram 900 depicts embodiments of the automated content entry detection system 140, wherein attributes of entries are passed from the client device 160 to a server executing the automated content entry detection system 140. In such embodiments, measurements and attributes may be collected and passed from the client device 160 to the automated content entry detection system 140 in real-time, such that the automated content entry detection system 140 may generate scores based on entries dynamically.

According to the interaction diagram 900, at operation 905, the client device 160 receives or otherwise generates an input into a first data entry field that may be presented within a GUI at the client device 160, and wherein the input comprises one or more attributes.

At operation 910, the client device 160 passes the first input and the one or more attributes of the first input, to a server executing the automated content entry detection system 140 as a first entry that comprises the first input. In some embodiments, the automated content entry detection system 140 may maintain a constant, real-time stream of communication with the client device 160, in order to continually receive attributes of inputs measured and collected by the client device 160.

At operation 915, the automated content entry detection system 140 determines behavioral data of the first entry based on the one or more attributes of the first input, collected at the client device 160.

At operation 920, the automated content entry detection system 140 generates a score to be assigned to the user account based on the one or more attributes of the first input, and at operation 925, the automated content entry detection system 140 determines the score of the user account transgresses the threshold value.

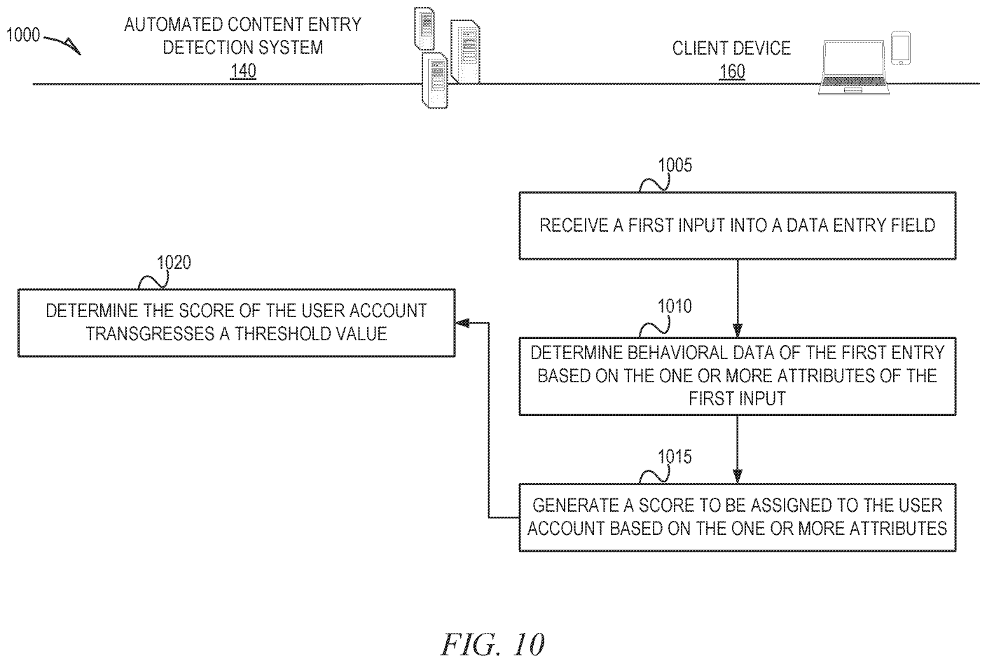

FIG. 10 is an interaction diagram 1000 illustrating various operations performed by the automated content entry detection system 140, according to an example embodiment. The interaction diagram 1000 depicts embodiments of the automated content entry detection system 140, wherein attributes of entries collected and maintained at the client device 160 in order to generate a score to be assigned to a user account. In such embodiments, the score may ultimately be passed from the client device 160 to the automated content entry detection system 140, wherein the automated content entry detection system 140 may determine whether or not the score of the user account transgresses a threshold value.

According to interaction diagram 1000, at operation 1005, the client device 160 receives the first input into a data entry field. For example, the data entry field may be presented within a GUI at the client device 160. The first input may comprise one or more attributes collected and measured by the client device 160, including for example, keystroke dynamics, motion data, image data, as well as temporal data.

At operation 1010, the client device 160 determines behavioral data of the first entry based on the one or more attributes of the first input, and at operation 1015, generates a score to be assigned to the user account based on the behavioral data.

At operation 1020, the client device 160 passes the score to the automated content entry detection system 140, wherein the automated content entry detection system 140 may determine that the score transgresses a threshold value.

In such embodiments, the client device 160 may dynamically generate and pass on scores in real-time, as inputs are received by the client device 160, and attributes of the inputs are collected by the client device 160.

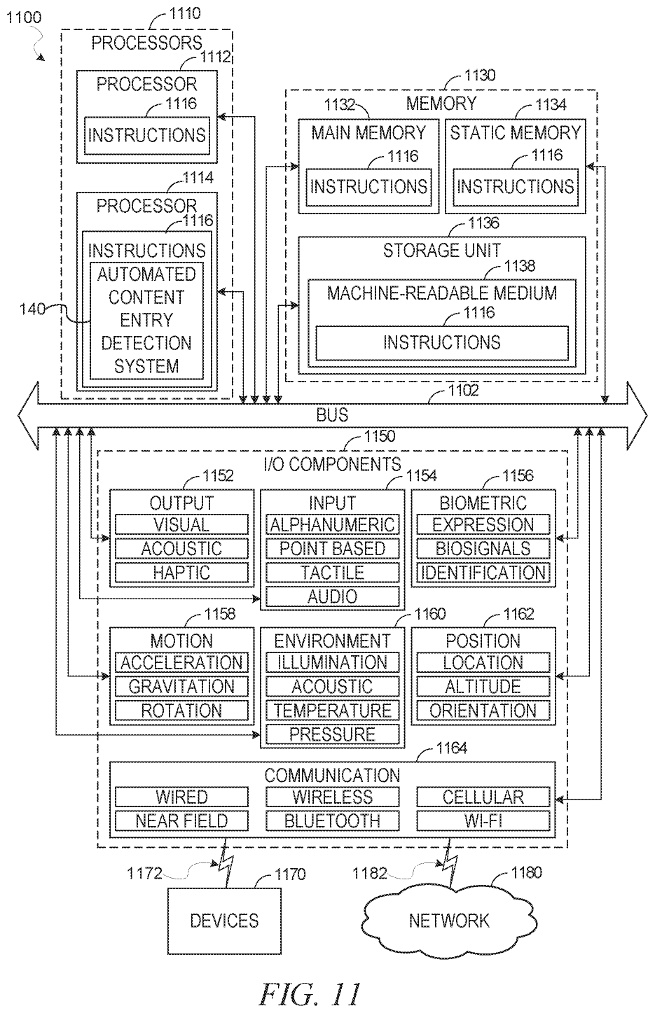

FIG. 11 illustrates a diagrammatic representation of a machine 1100 in the form of a computer system within which a set of instructions may be executed for causing the machine to perform any one or more of the methodologies discussed herein, according to an example embodiment. Specifically, FIG. 11 shows a diagrammatic representation of the machine 1100 in the example form of a computer system, within which instructions 1116 (e.g., software, a program, an application, an applet, an app, or other executable code) for causing the machine 1100 to perform any one or more of the methodologies discussed herein may be executed. In some embodiments, the instructions 1116 of the processors 1114 are specially configured to execute the modules of the automated content entry detection system 140. In such embodiments, the instructions 1116 may cause at least the processors 1114 of the machine 1100 to execute the methods depicted in FIGS. 2A-10. Additionally, or alternatively, the instructions 1116 may implement FIGS. 2A-10, and so forth. The instructions 1116 transform the general, non-programmed machine 1100 into a particular machine 1100 programmed to carry out the described and illustrated functions in the manner described. In alternative embodiments, the machine 1100 operates as a standalone device or may be coupled (e.g., networked) to other machines. In a networked deployment, the machine 1100 may operate in the capacity of a server machine or a client machine in a server-client network environment, or as a peer machine in a peer-to-peer (or distributed) network environment. The machine 1100 may comprise, but not be limited to, a server computer, a client computer, a personal computer (PC), a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 1116, sequentially or otherwise, that specify actions to be taken by the machine 1100. Further, while only a single machine 1100 is illustrated, the term “machine” shall also be taken to include a collection of machines 1100 that individually or jointly execute the instructions 1116 to perform any one or more of the methodologies discussed herein.

The machine 1100 may include processors 1110, memory 1130, and I/O components 1150, which may be configured to communicate with each other such as via a bus 1102. In an example embodiment, the processors 1110 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1112 and a processor 1114 that may execute the instructions 1116. The term “processor” is intended to include multi-core processors that may comprise two or more independent processors (sometimes referred to as “cores”) that may execute instructions contemporaneously. Although FIG. 11 shows multiple processors, the machine 1100 may include a single processor with a single core, a single processor with multiple cores (e.g., a multi-core processor), multiple processors with a single core, multiple processors with multiples cores, or any combination thereof.

The memory 1130 may include a main memory 1132, a static memory 1134, and a storage unit 1136, both accessible to the processors 1110 such as via the bus 1102. The main memory 1130, the static memory 1134, and storage unit 1136 store the instructions 1116 embodying any one or more of the methodologies or functions described herein. The instructions 1116 may also reside, completely or partially, within the main memory 1132, within the static memory 1134, within the storage unit 1136, within at least one of the processors 1110 (e.g., within the processor's cache memory), or any suitable combination thereof, during execution thereof by the machine 1100.

The I/O components 1150 may include a wide variety of components to receive input, provide output, produce output, transmit information, exchange information, capture measurements, and so on. The specific I/O components 1150 that are included in a particular machine will depend on the type of machine. For example, portable machines such as mobile phones will likely include a touch input device or other such input mechanisms, while a headless server machine will likely not include such a touch input device. It will be appreciated that the I/O components 1150 may include many other components that are not shown in FIG. 11. The I/O components 1150 are grouped according to functionality merely for simplifying the following discussion and the grouping is in no way limiting. In various example embodiments, the I/O components 1150 may include output components 1152 and input components 1154. The output components 1152 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1154 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1150 may include biometric components 1156, motion components 1158, environmental components 1160, or position components 1162, among a wide array of other components. For example, the biometric components 1156 may include components to detect biometric data including: expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1158 may include acceleration sensor components (e.g., accelerometer), gravitation sensor components, rotation sensor components (e.g., gyroscope), and so forth. The environmental components 1160 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1162 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1150 may include communication components 1164 operable to couple the machine 1100 to a network 1180 or devices 1170 via a coupling 1182 and a coupling 1172, respectively. For example, the communication components 1164 may include a network interface component or another suitable device to interface with the network 1180. In further examples, the communication components 1164 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1170 may be another machine or any of a wide variety of peripheral devices (e.g., a peripheral device coupled via a USB).

Moreover, the communication components 1164 may detect identifiers or include components operable to detect identifiers. For example, the communication components 1164 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1164, such as location via Internet Protocol (IP) geolocation, location via Wi-Fi® signal triangulation, location via detecting an NFC beacon signal that may indicate a particular location, and so forth.

The various memories (i.e., 1130, 1132, 1134, and/or memory of the processor(s) 1110) and/or storage unit 1136 may store one or more sets of instructions and data structures (e.g., software) embodying or utilized by any one or more of the methodologies or functions described herein. These instructions, when executed by processor(s) 1110 cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms machine-storage media, computer-storage media, and device-storage media specifically exclude carrier waves, modulated data signals, and other such media, at least some of which are covered under the term “signal medium” discussed below.

In various example embodiments, one or more portions of the network 1180 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 1180 or a portion of the network 1180 may include a wireless or cellular network, and the coupling 1182 may be a Code Division Multiple Access (CDMA) connection, a Global System for Mobile communications (GSM) connection, or another type of cellular or wireless coupling. In this example, the coupling 1182 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks. Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1116 may be transmitted or received over the network 1180 using a transmission medium via a network interface device (e.g., a network interface component included in the communication components 1164) and utilizing any one of a number of well-known transfer protocols (e.g., hypertext transfer protocol (HTTP)). Similarly, the instructions 1116 may be transmitted or received using a transmission medium via the coupling 1172 (e.g., a peer-to-peer coupling) to the devices 1170. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1116 for execution by the machine 1100, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method comprising:
receiving a first entry from a user account, the first entry comprising a first input into a data entry field;
determining behavioral data of the first entry, the behavioral data including one or more attributes of the first entry;
generating a score to be assigned to the user account based on at least the one or more attributes of the first entry;
determining the score of the user account transgresses a threshold value;
receiving a second entry from the user account; and
denying the second entry from the user account based on the score of the user account transgressing the threshold value.

2. The method of claim 1, wherein the determining the behavioral data of the first entry includes:
determining the first input of the first entry includes a machine generated input from an allowed user input tool; and
wherein the generating the score to be assigned to the user account is based on the determining that the first input includes the machine generated input from the allowed user input tool.

3. The method of claim 2, wherein the machine generated input includes a copy and paste of content within the first input.

4. The method of claim 1, wherein the first entry includes a tactile entry, and wherein the determining the behavioral data of the first entry includes:
determining an input pressure of the tactile entry; and
wherein the generating the score to be assigned to the user account is based on the input pressure of the tactile entry.

5. The method of claim 1, wherein the first entry includes a tactile entry, and wherein the determining the behavioral data of the first entry includes:
detecting a fluctuation of an input pressure of the tactile entry; and
wherein the generating the score to be assigned to the user account is based on the fluctuation of the input pressure.

6. The method of claim 1, wherein the first entry from the user account is received from a client device, the one or more attributes of the first entry includes motion data from the client device, and wherein the generating the score includes:
generating the score to be assigned to the user account based on the motion data from the client device.

7. The method of claim 1, wherein the one or more attributes of the first entry include keystroke dynamics, and wherein the method further comprises:
detecting a correction of an error within the first input based on the keystroke dynamics of the first entry; and
wherein the generating the score to be assigned to the user account is based on the correction of the error.

8. The method of claim 1, wherein the determining the behavioral data of the first entry includes:
accessing the user account in response to the receiving the first entry that comprises the first input into the data entry field, the user account comprising a set of inputs;
performing a comparison of the first input of the first entry to the set of inputs of the user account;
identifying one or more duplicate inputs to the first input among the set of inputs based on the comparison of the first input to the set of inputs of the user account; and
wherein the generating the score to be assigned to the user account is based on the identifying the one or more duplicate inputs to the first input.

9. A system comprising:
one or more processors; and
a non-transitory memory storing instructions that configure the one or more processors to perform operations comprising:
receiving a first entry from a user account, the first entry comprising a first input into a data entry field;
determining behavioral data of the first entry, the behavioral data including one or more attributes of the first entry;
inputting the one or more attributes into a machine prediction module;
receiving an output from the machine prediction module, the output indicating a probability that the entry input received from the user account is generated by an automated agent;
receiving a second entry from the user account; and
denying the second entry from the user account based on the output.

10. The system of claim 9, wherein the one or more attributes of the first entry include a time of the first entry, and wherein the operations further comprise:
accessing the user account in response to the receiving the first entry that comprises the first input into the data entry field, the user account comprising user activity data;
determining a time period based on the user activity data;
performing a comparison of the time of the first entry with the time period; and
wherein the one or more attributes includes a comparison of the time of the first entry and the time period.

11. The system of claim 9, wherein the determining the behavioral data of the first entry includes:
determining a likelihood that the first input of the first entry includes a machine generated input from an allowed user input tool; and
wherein the one or more attributes includes the likelihood that the first input includes the machine generated input from the allowed user input tool.

12. The system of claim 11, wherein the machine generated input includes a copy and paste of content within the first input.

13. The system of claim 9, wherein the first entry includes a tactile entry, and wherein the determining the behavioral data of the first entry includes:
determining an input pressure of the tactile entry; and
wherein the one or more attributes includes the input pressure of the tactile entry.

14. The system of claim 9, wherein the first entry includes a tactile entry, and wherein the determining the behavioral data of the first entry includes:
detecting a fluctuation of an input pressure of the tactile entry; and
the one or more attributes includes the fluctuation of the input pressure.

15. The system of claim 9, wherein the first entry from the user account is received from a client device, and the one or more attributes of the first entry includes motion data from the client device.

16. The system of claim 9, wherein the one or more attributes of the first entry include keystroke dynamics, and wherein the operations further comprise:
detecting a correction of an error within the first input based on the keystroke dynamics of the first entry.

17. The system of claim 9, wherein the determining the behavioral data of the first entry includes:
accessing the user account in response to the receiving the first entry that comprises the first input into the data entry field, the user account comprising a set of inputs;
performing a comparison of the first input of the first entry to the set of inputs of the user account;
identifying one or more duplicate inputs to the first input among the set of inputs based on the comparison of the first input to the set of inputs of the user account.

18. A non-transitory machine-readable storage medium including instructions that, when executed by a machine, cause the machine to perform operations comprising:
receiving a first entry from a user account, the first entry comprising a first input into a data entry field;
determining behavioral data of the first entry, the behavioral data including one or more attributes of the first entry;
generating a score to be assigned to the user account based on at least the one or more attributes of the first entry;
determining the score of the user account transgresses a threshold value;
receiving a second entry from the user account; and
denying the second entry from the user account based on the score of the user account transgressing the threshold value.

19. The non-transitory machine-readable storage medium of claim 18, wherein the one or more attributes of the first entry include keystroke dynamics, and wherein the determining the behavioral data of the first entry includes:
determining the first input of the first entry includes a machine generated input from an allowed user input tool; and
wherein the generating the score to be assigned to the user account is based on the determining that the first input includes the machine generated input from the allowed user input tool.

20. The non-transitory machine-readable storage medium of claim 18, wherein the one or more attributes of the first entry include keystroke dynamics, and wherein the machine generated input includes a copy and paste of content within the first input.
